(19) United States
(12) Patent Application Publication
(10) Pub. No.: US 2014/0134091 A1
(43) Pub. Date: May 15, 2014

(54) Deposition Cartridge for Production Materials via the Chemical Vapor Deposition Process

(71) Applicant: Kagan Ceran, Carlsbad, CA (US)

(72) Inventor: Kagan Ceran, Carlsbad, CA (US)

(73) Assignee: GREENLY GROUP FOR SOLAR TECHNOLOGIES, LTD., Road Town, Tortola (VG)

(21) Appl. No.: 14/130,662

(22) PCT Filed: Jul. 1, 2012
(86) PCT No.: PCT/US2012/045176

§ 371 Date: Jan. 2, 2014

Related U.S. Application Data
(63) Continuation-in-part of application No. 12/597,151, filed on Oct. 22, 2009, now Pat. No. 8,449,940.
(60) Provisional application No. 61/504,145, filed on Jul. 1, 2011.
(60) Provisional application No. 61/504,148, filed on Jul. 1, 2011.
(60) Provisional application No. 60/913,997, filed on Apr. 25, 2007.

(51) Int. Cl. B01J 19/32; C01B 33/027

(52) U.S. Cl. CPC B01J 19/32; C01B 33/027
USPC 423/349; 422/186.21

(57) ABSTRACT

An electrically heated deposition cartridge for use in the production of materials via the chemical vapor deposition process that has (i) a higher ratio of surface area to volume than a seed rod pair, (ii) a higher ratio of starting effective deposition surface area to final effective deposition surface area than a seed rod pair, and (iii) a higher ratio of effective deposition surface area to gross surface area than a basic deposition plate, which are achieved by reaching and maintaining the desired temperatures on all desired surfaces of the deposition cartridge, which in turn is achieved by distribution of the desired amount of current through all desired cross-sectional areas of the deposition cartridge.

The present patent application incorporates by reference in its entirety U.S. patent application Ser. No. 12/597,151 (the “'151 patent application”), Deposition of high-purity silicon via high-surface-area gas-solid or gas-liquid interfaces and recovery via liquid phase, filed Oct. 22, 2009. This application also incorporates by reference in its entirety the co-pending application entitled: CARTRIDGE REACTOR FOR PRODUCTION OF MATERIALS VIA THE CHEMICAL VAPOR DEPOSITION PROCESS filed concurrently herewith (whose application Ser. No. ______ will be added once known). The present patent application also claims benefit of U.S. provisional patent application No. 61504148 (the “'148 provisional patent application”), Deposition cartridge for production of high-purity amorphous and crystalline silicon and other materials, filed Jul. 1, 2011, and provisional patent application No. 61504145 (the “'145 provisional patent application”), filed Jul. 1, 2011, Cartridge reactor for production of high-purity amorphous and crystalline silicon and other materials, which are both hereby incorporated herein in their entireties. In the '151 patent application, the term “deposition plates” is defined as the surfaces upon which the silicon is deposited, but for the purposes of enhanced clarity when describing actual physical components in this patent application, a “deposition surface” is defined as a surface upon which materials are deposited and a “deposition plate” is defined as an actual physical flat plate (an object with significantly larger surface areas on its sides relative to its edges) upon which materials are deposited, preferably on both sides as well as one or more edges. Thus the sides and edges of a deposition plate are deposition surfaces. The term “deposition cartridge” is defined as the combination of distribution rods and a solid deposition plate or as simply a meander patterned deposition plate, either of which can incorporate an insulative layer or spacer. The term “Siemens reactor” is defined as a deposition reactor that has originally been designed to utilize seed rods.

### BACKGROUND

The '151 patent application describes the limitations of Siemens reactors as including:
1. The low average surface area of the polysilicon rods which results in a low volumetric deposition rate and hence low Siemens reactor productivity (as measured by the mass of polysilicon produced over a given period of time, typically metric tons per year)
2. The low ratio of surface area to volume of the polysilicon rods, which results in high energy consumption in order to maintain the surface temperature required to achieve deposition for the extended period of time required to achieve a meaningful deposition volume.
3. The labor-intensive and contamination-prone nature of the rod harvesting process

The invention described in the '151 patent application overcomes the first two limitations above by providing high-surface-area electrically heated deposition plates. Silicon is deposited at a high volumetric rate onto these plates through the CVD process and then recovered by additional heating of the plates. The additional heating causes a very thin layer of the deposited polysilicon at the plate interfaces to liquefy and the solid crust of deposited polysilicon can be pulled away from the plates either mechanically or by gravity. Using large-sized plates in a Siemens reactor increases the productivity of the reactor relative to using conventional seed rods whereas using smaller-sized plates reduces the energy consumption of the reactor while maintaining the same productivity relative to using seed rods.

However, utilizing the deposition plates alone does not address the third limitation above of the labor-intensive and contamination prone nature of the harvesting process. To overcome this limitation, the invention described in the '151 patent application also provides a new deposition reactor for use with the plates where both deposition and recovery can occur inside the reactor.

Despite their significant advantages over conventional seed rods, the deposition plates described in the '151 patent application suffer from some limitations of their own. While the '151 patent application calls out a number of appropriate materials of construction for these deposition plates such as tungsten, silicon nitride, silicon carbide, graphite, and alloys, composites, and mixtures thereof, it describes these deposition plates as being several millimeters thick and up to several meters in length and height. It is further describes these plates as being electrified by connecting a negative electrode to one end of the plate and a positive electrode to the other end.

Given such an arrangement, it is difficult to distribute the electrical current flow evenly through the entire cross sectional area of the deposition plates due to short circuiting and therefore it is difficult to achieve even heating of the entire plate surfaces to the desired temperatures. This short-circuiting is only exacerbated if the material being deposited on the un-insulated surfaces of the deposition plates is a semiconductor such as polysilicon, which is conductive at high temperatures. Thus the effective deposition surface area of the plates is less than the gross surface area of the plates (although still considerably higher than the average deposition surface area of polysilicon rods). Since deposition rate, i.e., production rate, is proportional to average deposition surface area, the production rate of a reactor that can accommodate the gross dimensions of these deposition plates is not maximized since the ratio of deposition surface area to gross surface area is not maximized. Reactors operating at such production rates consequently yield production costs that are not minimized.

The inability of the deposition plates to reach the optimal deposition temperature over their entire surface areas also has implications during the recovery of the crust. There may be areas of the deposition plate that have reached temperatures that are less than the optimal deposition temperature but still high enough to effect some crust formation. During recovery of the crust, it may not be possible to quickly heat these areas to the deposition plates to or above the melting temperature of the material, resulting in excessive melting of the crust in the properly heated areas, or resulting in only partial detachment and recovery. Finally, these deposition plates have no built-in mechanism for preventing deposition on surfaces that might obstruct separation of the crust.

### SUMMARY

The present invention overcomes the limitations of the deposition plates described above by providing an electrically heated deposition cartridge with a large deposition surface area which is constructed of distribution rods and a solid deposition plate or of a meander deposition plate alone, and which can incorporate an electrically insulative layer or spacer. The desired amount of current can be distributed through the desired cross-sectional areas of the deposition cartridge such that the desired temperatures can be reached and maintained on all desired surfaces of the deposition cartridge.

The ability to achieve the desired temperature on all desired surfaces by distribution of the desired amount of current through the desired cross-sectional areas and by proper insulation allows the deposition cartridges to have effective deposition surface areas that are maximized relative to their gross surface areas. This in turn maximizes the productivity of the reactors in which their gross dimensions can be accommodated and therefore minimizes production costs. Recovery of the crust of material is simplified by the simultaneous heating characteristics of the deposition cartridges and by their ability to limit deposition on obstructing surfaces by selective heating in addition to external cooling.

These deposition cartridges can be used in any quantity in any deposition reactor, including Siemens reactors as a replacement for seed rods, and can be oriented in any direction including vertically and/or horizontally. Detachment of the crust from the deposition cartridge through additional heating of the deposition cartridge such that a thin layer of the crust liquefies at the deposition cartridge interfaces can be achieved either in the reactor or outside the reactor by first harvesting the encrusted deposition cartridges. The crusts can then be completely separated from the deposition cartridges through the application of any force including gravitational or mechanical force. The use and benefits of the deposition cartridges can be extended to all materials that can be produced via the CVD process, including but not limited to polysilicon.

### BRIEF DESCRIPTION OF DRAWINGS

FIG. 1: shows elevation and plan sections of one preferred embodiment of a deposition cartridge with a solid deposition plate and distribution rods

FIG. 2: shows elevation and plan sections of one preferred embodiment of a deposition cartridge with a meander deposition plate

FIG. 3: shows elevation and plan sections of one preferred embodiment of a deposition cartridge with a meander deposition plate and cooler outer edges

FIG. 4: shows elevation and plan sections of one preferred embodiment of a deposition cartridge with a meander deposition plate and separate outer paths

FIG. 5: shows a perspective of one preferred embodiment of deposition cartridges for a crucible reactor

FIG. 6: shows a perspective of one preferred embodiment of a deposition cartridge for a Siemens reactor

FIG. 7: shows a plan section of an 18-pair Siemens reactor with polysilicon rods at the beginning and end of the deposition run

FIG. 8: shows a plan section of one preferred embodiment of an 18-pair Siemens reactor with deposition cartridges

FIG. 9: shows an elevation section of one preferred embodiment of a deposition cartridge mounted in a Siemens reactor

FIG. 10: shows a plan section of one preferred embodiment of a deposition cartridge mounted in a Siemens reactor

FIG. 11: shows a front elevation section of one preferred embodiment of a deposition cartridge mounted in as Siemens reactor

FIG. 12: shows an elevation section of one preferred embodiment of a U-shaped deposition cartridge mounted in a Siemens reactor

FIG. 13: shows a plan section of one preferred embodiment of a U-shaped deposition cartridge mounted in a Siemens reactor

FIG. 14: shows a front elevation section of one preferred embodiment of a U-shaped deposition cartridge mounted in a Siemens reactor

### DESCRIPTION

To achieve resistive heating of a material, an electrical current must be passed through it. However, current will always travel through the path of least resistance. The formula for resistance is given as:

R=ρ*L/S

### Where:

R=resistance of a specific path through a specific material, in Ohms
P=bulk resistivity of that material in Ohm*meter
L=length of the path, in meters
S=cross sectional area of the path through which the current is traveling

If electrodes are connected to the top two corners of a square plate of conductive material and the power is switched on, the majority of the current will tend to move between one electrode and the other electrode in a straight and narrow path across the top of the plate, with little current reaching the lower section of the plate. Similarly, if two separate pieces of material are connected in parallel, the majority of the current will tend to travel through the material with the lower resistance. If the two separate pieces are made from the same material, the majority of the current will tend to travel through the piece with the lowest ratio of length to cross sectional area, as this piece will have the lower resistance. If the two separate pieces have the same ratio of length to cross sectional area but are made from different materials, the majority of the current will tend to travel through the material with the lower bulk resistivity.

Using the principles above it is possible to select materials of specific bulk resistivities and size them so as to direct the flow of current along desired paths. In the case of a deposition plate, the goal is to achieve even heating of the entire surfaces to a desired temperature, which requires that current pass evenly through the entire cross-sectional area of the plate from one side to the other. The task then becomes to distribute the current along one entire edge of the deposition plate and collect it along the entire opposing edge. This can be achieved by attaching distribution rods to both edges such that the resistance of the rods is lower than the resistance of the deposition plate. In this manner, current will first pass down the entire length of one distribution rod before evenly passing through the entire cross section of the deposition plate to be evenly carried away by the opposing rod. If the distribution rods and the deposition plate are made of the same material, then the ratio of length to cross sectional area of the rods needs to be smaller than the ratio of length to cross sectional area of the plate. Even if the deposition plate is quite thin, if it is high enough this ratio can be quite low. Consequently the distribution rod will have to have a sufficiently large cross sectional area to ensure the current first travels down its entire length. Suitable materials for this configuration where the distribution rods and the deposition plate are made of the same material include but are not limited to tungsten, silicon nitride, silicon carbide, graphite, and alloys and composites thereof.

As an alternative configuration, the distribution rods can be made from a material that has a lower bulk resistivity than the material of the deposition plate, thus allowing the cross section of the rods to be reduced. Suitable combinations of materials for this configuration include but are not limited to graphite for the distribution rods and silicon carbide for the deposition plate or tungsten for the rods and silicon nitride for the plate.

As yet another alternative configuration, it is possible to integrate the functionality of the distribution rods directly into the deposition plate by machining a meander pattern into the deposition plate such that the current travels up and down through a narrow path that makes its way from one side of the plate to the other side. Such a configuration provides for the resistive heating of a large surface area while the current remains evenly distributed throughout a relatively narrow path.

In any of the configurations above, it may be desirable to apply a layer of electrically insulative material over the entire deposition surfaces of the distribution rods and deposition plate. This insulative material would preferably have a much higher bulk resistivity than the materials of the distribution rods and deposition plate so as to ensure that the vast majority of the current stayed within the rods and plate and did not pass into the material being deposited on the surface of the insulative layer, such as polysilicon. Polysilicon is a semiconductor whose resistivity drops significantly as its temperature is increased and at average deposition temperatures of 1150° C. it is quite conductive. Furthermore, as deposition progresses and the thickness of the polysilicon crust increases, its ratio of length to cross sectional area decreases, further reducing its resistance. Without an insulative layer, more and more of the current would start to flow through the crust as it became thicker, effectively short-circuiting the deposition plate. The deposition plate would cease to heat properly and further deposition of polysilicon would be self-curtailed. Suitable combinations of materials to prevent this include but are not limited to graphite for the distribution rods and deposition plate and silicon carbide or silicon nitride for the insulative layer. This insulative layer can be applied over the distribution rods and deposition plate in a number of formats including but not limited to chemical vapor deposition, pre-ceramic polymeric pastes, and ceramic matrix composites.

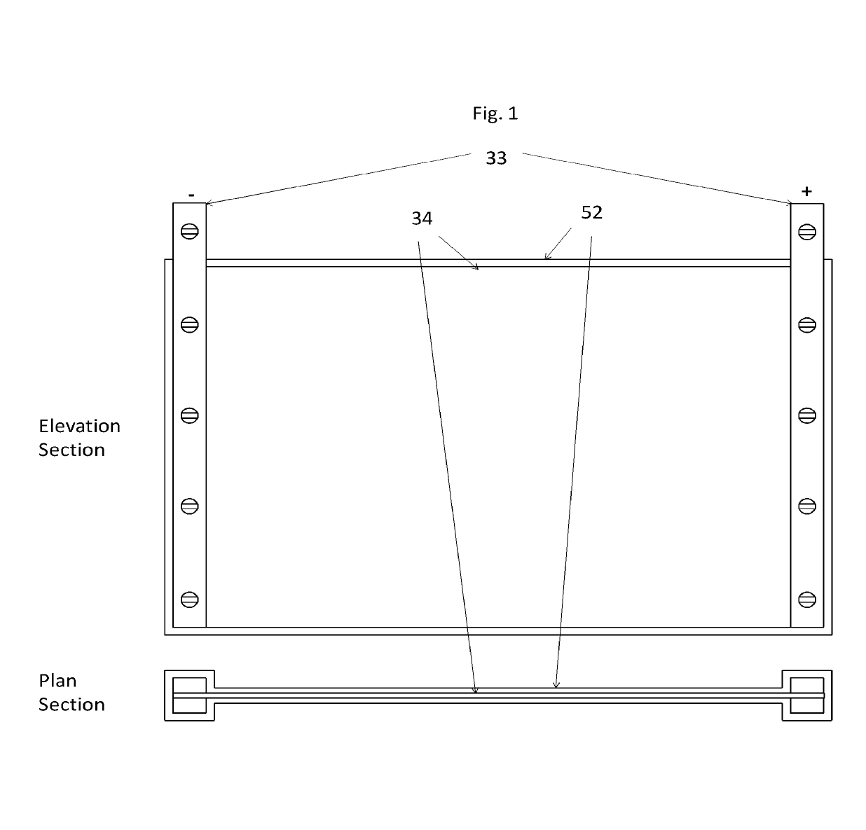

FIG. 1 shows one preferred embodiment of a deposition cartridge 2 incorporating the distribution and insulation features describe above. In this preferred embodiment, the deposition cartridge 2 is composed of a solid deposition plate 34 attached to two distribution rods 33 at either end. The resistance of the distribution rods 33 is lower than the resistance of the solid deposition plate 34 such that current first flows down the entire length of one distribution rod 33 before flowing evenly across the entire cross sectional area of the solid deposition plate 34 and being carried away by the other distribution rod 33. This creates even resistive heating of the entire deposition surfaces. The whole assembly, with the exception of the ends of the distribution rods 33, which must remain uncovered to achieve good electrical contact with other electrical components, is covered in an insulative layer 52 that blocks the passage of current from the distribution rods 33 and solid deposition plate 34 to the material (not shown) which deposits on the deposition cartridge 2.

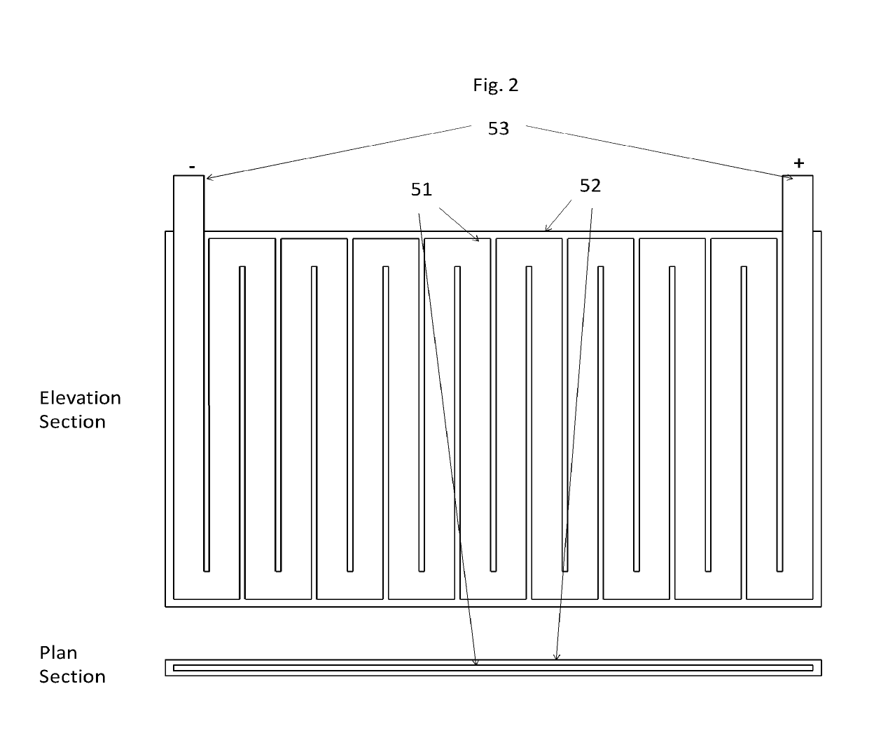

FIG. 2 shows one preferred embodiment of a deposition cartridge 2 where the functionality of the distribution bars 33 and solid deposition plate 34 are integrated into a single meander deposition plate 51. The meander pattern of slots machined into the meander deposition plate 51 creates a winding path that provides a large surface area in total yet remains narrow enough such that current passes evenly through its cross sectional area. The first and last meander legs are extended so as to form electrode tabs 53 for connection to other electrical components. The whole deposition cartridge 2 with the exception of the electrode tabs 53 is covered in an insulative layer 52 that also creates contiguous deposition surfaces by closing over the meander slots. The thermal conductivity of the insulative layer 52 is such that no appreciable thermal gradients develop on it surface between areas directly above the meander paths and those directly above the meander slots. This even heating allows for even deposition of silicon over the entire surfaces of the deposition cartridge 2.

Both FIGS. 1 and 2 show preferred embodiments of deposition cartridges 2 where material is kept from depositing along the top edges of the deposition cartridge 2 by the proximity of an external cooling source such as a water cooled reactor wall. Thus the deposited material forms a crust that covers the remaining three edges and both sides of the deposition cartridge 2 and is recovered in the direction opposite the un-encrusted edge upon subsequent further heating.

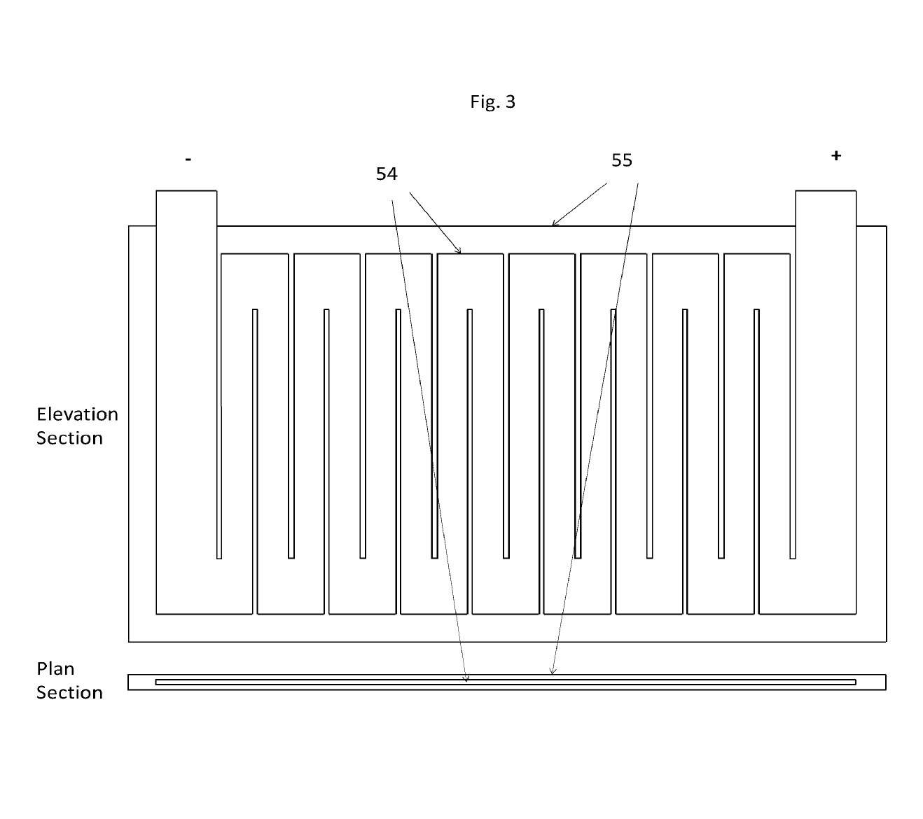

FIG. 3 shows one preferred embodiment of a deposition cartridge 2 that incorporates a meander deposition plate with wider outer paths 54 and an insulative layer with wider outer edges 55. When current passes through the deposition plate with wider outer paths 54, these outer paths are heated to a lesser degree than the inner meander paths since their cross sectional area is larger and therefore their resistance is lower. The insulative layer with wider outer edges 55 dissipates this lesser heat even further through conductive and convective losses such that the edges of the deposition cartridge 2 are below the temperature necessary for appreciable deposition. Preventing crust formation around all the edges of the deposition cartridge 2, i.e., limiting it to just the two sides of the deposition cartridge 2, allows for unobstructed and multidirectional recovery of this crust upon subsequent further heating.

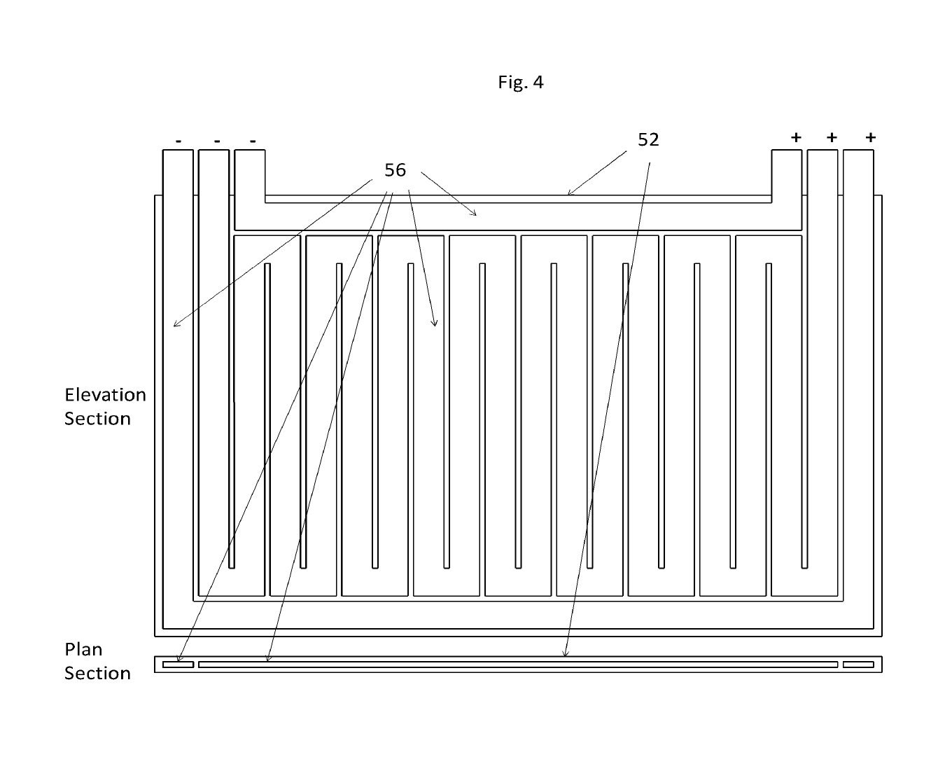

FIG. 4 shows one preferred embodiment of a deposition cartridge 2 that incorporates a meander deposition plate with separate outer paths 56. These outer paths are kept un-electrified during the deposition step so that the edges of the deposition cartridge 2 stay cooler than the sides and hence free from crust formation. They are electrified, along with the inner paths, during the recovery step to provide any additional heating that may be necessary to simultaneously detach the edges and center of the crust that has formed on both sides of the deposition cartridge 2. Simultaneous rapid detachment of all areas of the crust minimizes interface liquefaction and hence possible diffusion of contaminants into the crust as well as minimizes energy consumption.

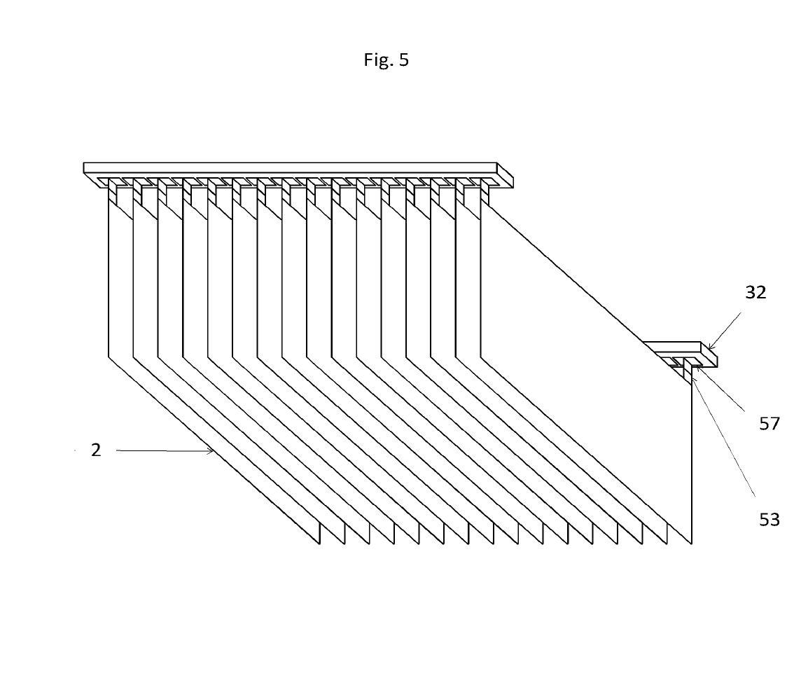

Deposition cartridges 2 can be used in any deposition reactor including a purpose build cartridge reactor and a Siemens reactor. FIG. 5 shows one preferred embodiment of an array of deposition cartridges 2 for use in a purpose build cartridge reactor. There are 16 deposition cartridges 2 which are connected to two distribution bars 32 by electrode brackets 57 attached to their electrode tabs 53. The distribution bars 32 connect the deposition cartridges 2, either in parallel or in series, to an AC or DC power supply. As shown, the distribution bars 32 are positioned within the cartridge reactor and contact with other electrical components occurs through connection points in the reactor walls. However, there is nothing to preclude the electrode tabs 53 having contact with an externally positioned distribution bar or other electrical components through their own individual connection points through the reactor walls.

In a preferred embodiment, each deposition cartridge 2 is 42 cm high by 75 cm long and the spacing between deposition cartridges 2 is 5 cm. This spacing allows for a reasonable 2 cm thickness of crust to develop on each of the sides of the deposition cartridges 2 while still providing for an adequate 1 cm gap for deposition gas flow between the crusts by the end of the deposition cycle. This crust thickness and gap width can be adjusted to optimize deposition cycle time and deposition gas flow characteristics as desired. As shown, the total volume occupied by the array of all 16 deposition cartridges 2 is approximately 75 cm by 75 cm by 42 cm, which, taking into account the crust thickness, is intended to fit inside of a 85 cm by 85 cm crucible used for the production of multicrystalline ingots.

However, the dimensions, quantity, and spacing of the deposition cartridges 2 can easily be changed so that they can fit inside most sizes of crucible. This dimensional flexibility is useful as crystallization technology continues to improve and larger and larger crucibles are used. In another preferred embodiment, deposition cartridges 2 can also be sized to fit inside of a crucible with a circular plan section by making the deposition cartridges 2 toward the sides of the array successively shorter than the deposition cartridges 2 in the middle, such that the plan section of the array of deposition cartridges 2 becomes circular itself. This preferred embodiment allows the deposition cartridges 2 to be used in the production of monocrystalline ingots with the Czochralski crystallization process that involves the insertion of a rotating puller rod into the melt in a circular crucible and the extraction of a cylindrical monocrystal.

The deposition cartridges 2 are oriented vertically with the electrode tabs 53 pointed upward. This orientation brings the top edges of the deposition cartridges 2 in proximity with the water-cooled wall of the reactor top assembly, which consequently prevents deposition of material onto these top edges. Deposition of material is limited to the two sides and remaining three edges of each deposition cartridge 2 some distance below the top edge such that all surfaces on which deposition occurs are oriented in the same direction, i.e., vertically. This facilitates the subsequent step of heating the deposition cartridge 2 to or above the melting temperature of the material and separating the crust from the deposition cartridge 2 through application of a unidirectional force, such as gravity. However, nothing here precludes the orientation of the deposition cartridges 2 in any direction and the use of any force in addition to gravity to separate the crusts from the deposition cartridges 2.

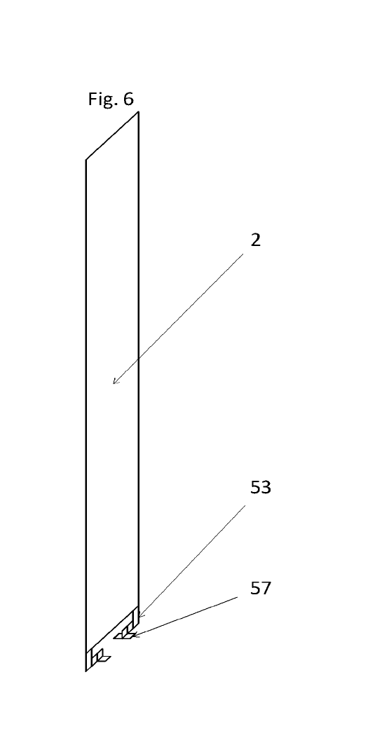

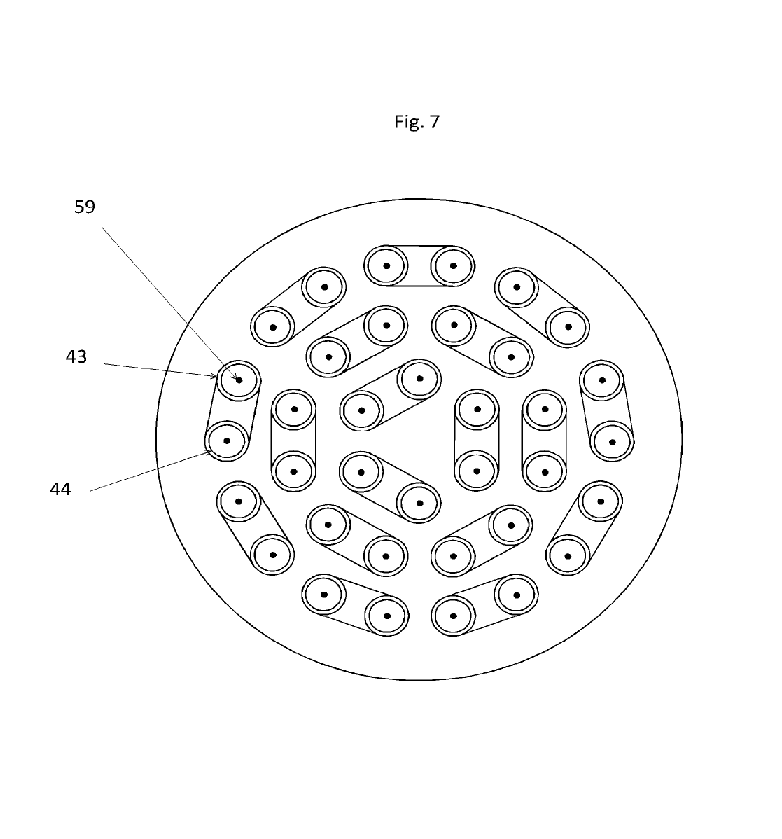

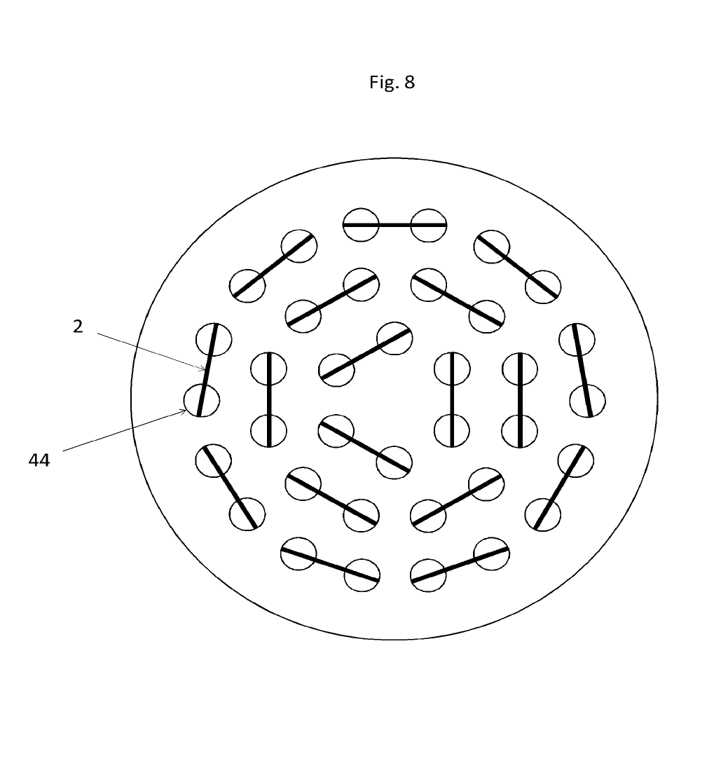

FIG. 6 shows one preferred embodiment of a deposition cartridge 2 for use in a Siemens reactor. The deposition cartridge 2 is fabricated to have the same dimensions as that of an end-of-run polysilicon rod pair, which are a height of approximately 200-240 cm and a length of approximately 40-50 cm. The electrode tabs 53 are pointed downward and are shaped so as to align over the Siemens reactor electrodes 44, to which they are attached with electrode brackets 57. Consequently such deposition cartridges 2 can be fitted in a Siemens reactor with little or no mechanical or electrical modifications for the purpose of increasing production capacity at the same unit energy consumption or reducing unit energy consumption at the same production capacity. To illustrate this point, FIG. 7 shows an 18-pair Siemens reactor with the outlines of the Siemens reactor electrodes 44, the beginning-of-run polysilicon rods 59, and the end-of-run polysilicon rods 43, and FIG. 8 shows one preferred embodiment of the same 18-pair Siemens reactor fitted with the deposition cartridges 2. The deposition cartridges 2 occupy the same space as the polysilicon rods and fit into the same electrodes yet provide a much higher average deposition surface area.

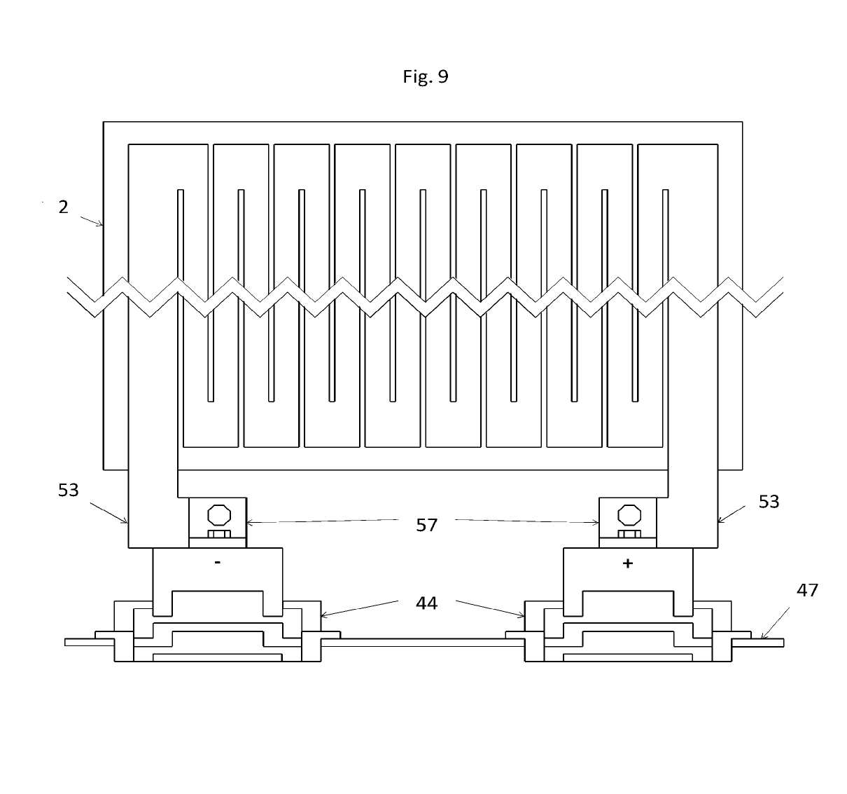

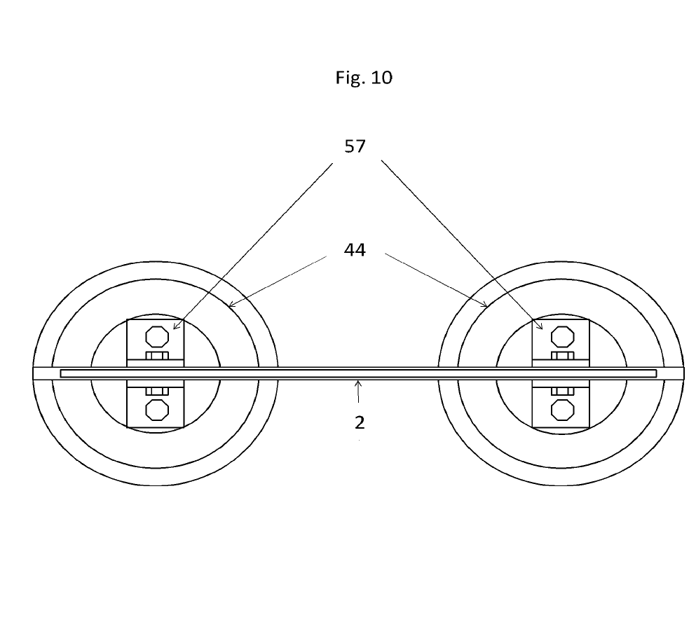

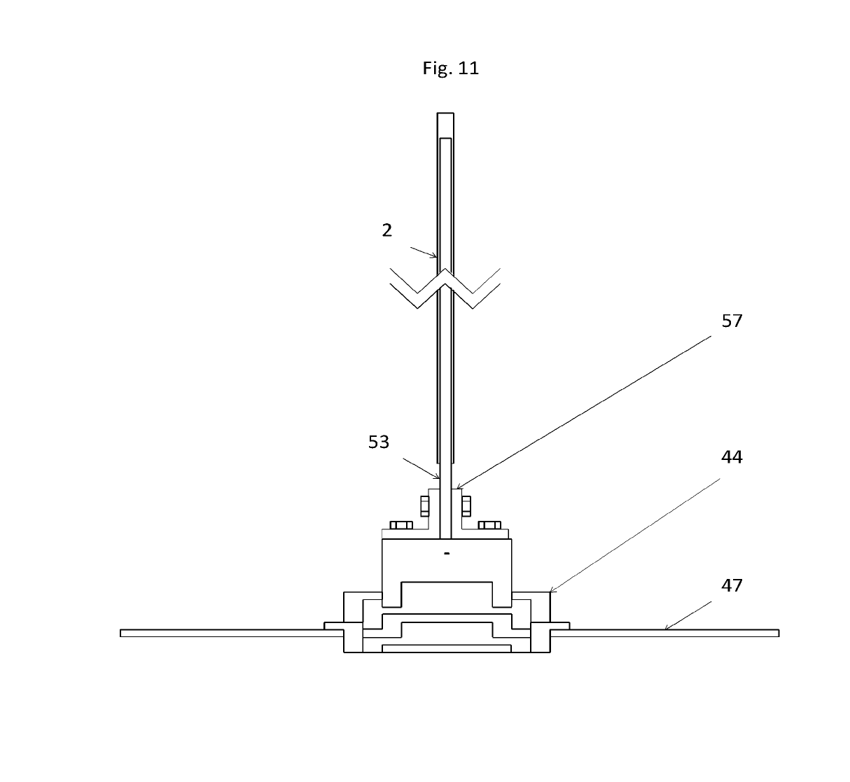

FIGS. 9-11 show one preferred embodiment of how a deposition cartridge 2 can be mounted in a Siemens reactor. The electrode tabs 53 are each screwed to two L-shaped electrode brackets 57 which in turn are screwed to the graphite holders of the Siemens reactor electrodes 44. The electrode tabs 53, which are integral to the deposition plate 54, and the electrode brackets 57 are preferably made from conductive yet structurally suitable materials including but not limited to carbon-carbon composite. Polysilicon crust formation along the bottom edge of the deposition cartridge 2 is prevented by (i) the design of the deposition cartridge 2, preferred embodiments of which are shown in FIGS. 3-4, (ii) the proximity of this bottom edge to the water cooled Siemens reactor baseplate 47, (iii) a shield (not shown) made of a suitable insulative, non-contaminating, and temperature-resistant material, including but not limited to silicon carbide, silicon nitride and various ceramics, which blocks the deposition gas from contacting the bottom edge, and (iv), any combination of (i), (ii), and (iii).

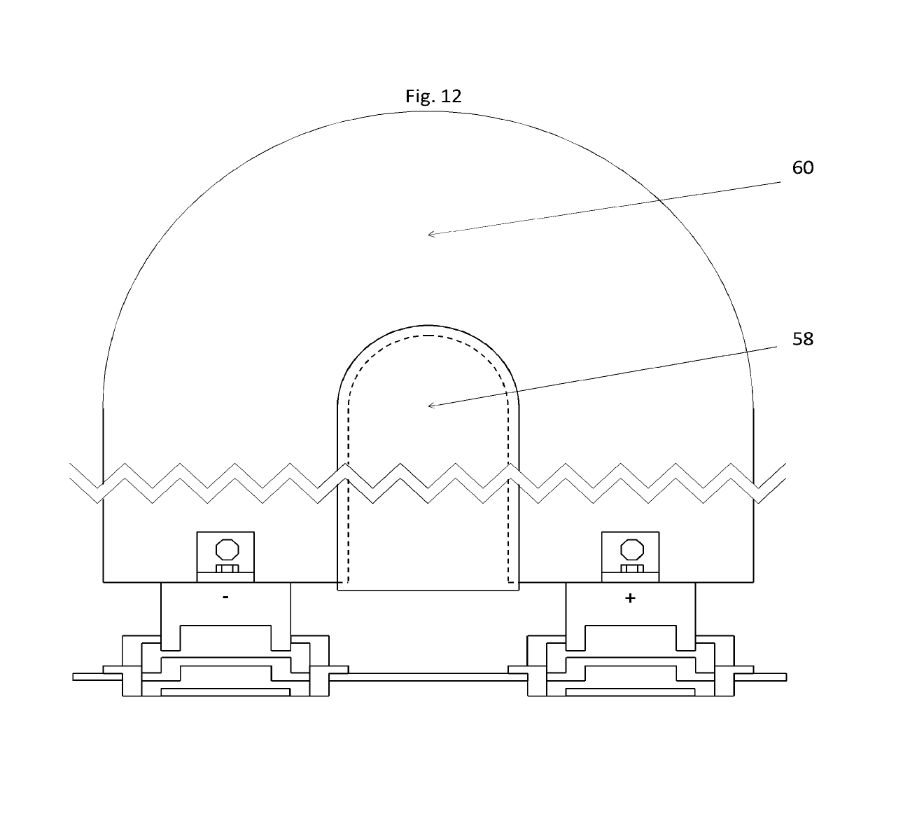

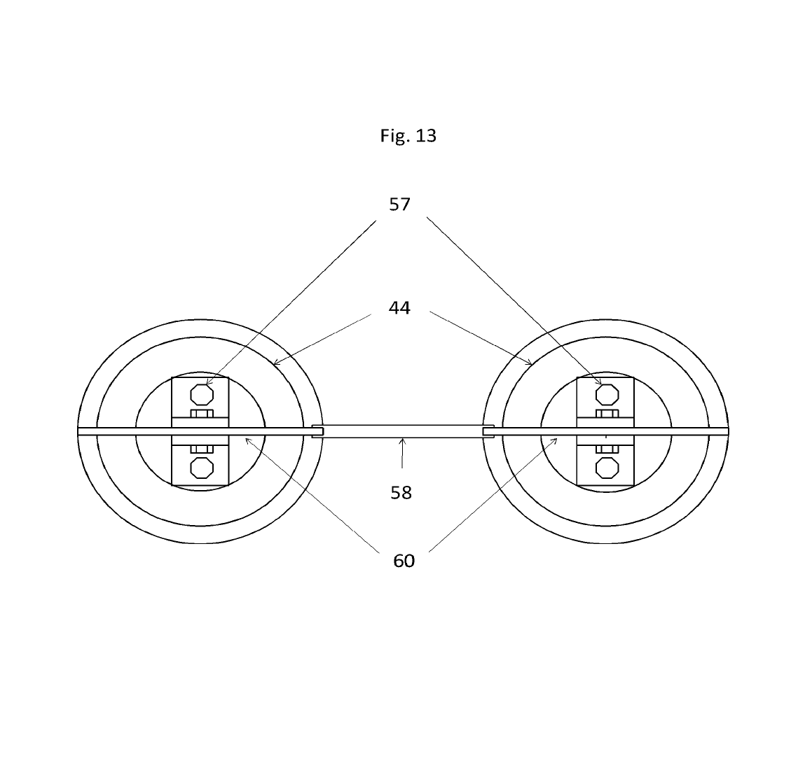

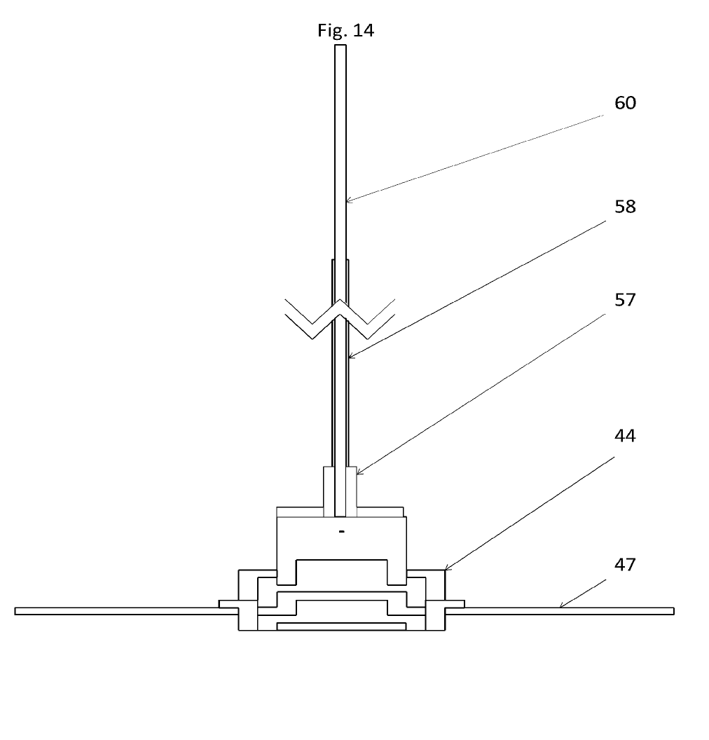

FIGS. 12-14 show one preferred embodiment of a deposition cartridge 2 specially suited for use in Siemens reactors. This deposition cartridge 2 has a U-shaped deposition plate 60, which does not have an insulative layer but instead has an insulative spacer 58 fitted between its two sides. Current flows along the U-shaped deposition plate 60, which is essentially a two-path meander deposition plate, between one Siemens reactor electrode 44 to the other thus heating the U-shaped deposition plate 60 and causing material to deposit on it. However, since the insulative spacer 58 is not heated, no material deposits on it. Consequently, the two sides of the U-shaped deposition plate 60, and the crust that has formed on them, are not short-circuited. The insulative spacer 58 also shields the entire inside edge of the U-shaped deposition plate 60 from crust formation and allows the crust to be separated from the U-shaped deposition plate 60 in the direction of the rounded end without obstruction.

What is claimed is:

1. An electrically heated deposition cartridge for use in the production of materials via the chemical vapor deposition process that has (i) a higher ratio of surface area to volume than a seed rod pair, (ii) a higher ratio of starting effective deposition surface area to final effective deposition surface area than a seed rod pair, and (iii) a higher ratio of effective deposition surface area to gross surface area than a basic deposition plate, which are achieved by reaching and maintaining the desired temperatures on all desired surfaces of the deposition cartridge, which in turn is achieved by distribution of the desired amount of current through all desired cross-sectional areas of the deposition cartridge.

2. The deposition cartridge in claim 1 where distribution of the desired amount of current throughout the desired cross-sectional areas of the deposition cartridge is achieved by connecting distribution rods of the appropriate material and size to a solid distribution plate of the appropriate material and size such that the distribution rods evenly distribute current throughout the entire cross-sectional area of the solid distribution plate.

3. The deposition cartridge in claim 2 where distribution of the desired amount of current throughout the desired cross-sectional area of the deposition cartridge is maintained, even when a conductive material is deposited on the deposition cartridge, by covering the distribution rods and solid deposition plate with an insulative layer such that current does not pass from the deposition cartridge to the material deposited on the deposition cartridge.

4. The deposition cartridge in claim 3 where the insulative layer is extended out for some distance beyond the outer edges of the distribution rods and solid deposition plate so as to form outer edges of the deposition cartridge that are cooler than the rest of the deposition cartridge during deposition and therefore do not develop a crust of deposited material on them

5. The deposition cartridge in claim 1 where distribution of the desired amount of current throughout the desired cross-sectional area of the deposition cartridge is achieved by combining the functionality of distribution rods and a solid deposition plate into a meander deposition plate of the appropriate material and size such that current flows evenly through paths created by machining alternating slots into the plate but where the total surface area provided by these paths is large.

6. The deposition cartridge in claim 5 where the outermost meander paths are wider than the inner meander paths so as to form outer edges of the deposition cartridge that are cooler than the rest of the deposition cartridge during deposition and therefore do not develop a crust of deposited material on them.

7. The deposition cartridge in claim 5 where there are separately electrified outer meander paths that can be turned off during deposition so as to form outer edges of the deposition cartridge that are cooler than the rest of the deposition cartridge during deposition and therefore do not develop a crust of deposited material on them, but that can be turned on during separation of the crust from the deposition plate, to provide heating for effective detachment of the edges of the crusts that have deposited on both sides of the deposition cartridge.

8. The deposition cartridge in claims 5-7 where distribution of the desired amount of current throughout the desired cross-sectional area of the deposition cartridge is maintained, even when a conductive material is deposited on the deposition cartridge, by covering the deposition cartridge with an insulative layer such that current does not pass from the deposition cartridge to the material deposited on the deposition cartridge, and where the insulative layer prevents deposition of material in the meander slots, which might otherwise obstruct subsequent separation of the crust.

9. The deposition cartridge in claim 8 where the insulative layer is extended out for some distance beyond the outer edges of the meander deposition plate so as to form outer edges of the deposition cartridge that are cooler than rest of the deposition cartridge during deposition and therefore do not develop a crust of deposited material on them.

10. The deposition cartridge in claim 1 where distribution of the desired amount of current throughout the desired cross-sectional area of the deposition cartridge is achieved by having a U-shaped deposition plate with an insulative spacer filling the area inside the U-shape such that current flows through the U-shaped deposition plate, heating up the U-shaped plate and causing a crust of material to form on the U-shaped plate, while the insulative spacer blocks crust from forming on the inside edges of the U-shaped deposition plate, which might otherwise obstruct separation of the crust from the deposition cartridge.

11. The deposition cartridge in claims 1-10 where crust formation over one or more edges of the deposition cartridge is prevented by a shield made of a suitable insulative, non-contaminating, and temperature-resistant material, including but not limited to silicon carbide, silicon nitride and various ceramics, which blocks the deposition gas from contacting those edges.

12. The deposition cartridge in claims 2, 5, 6, 9 and 10 where the distribution bars, solid deposition plates, and meander deposition plate are made from materials with the appropriate electrical, thermal, and structural properties including but not limited to tungsten, silicon nitride, silicon carbide, graphite, and alloys, composites, and mixtures thereof.

13. The deposition cartridge in claims 3, 4, 18, 9, and 10 where the insulative layer or spacer is made from materials with the appropriate electrical, thermal, and structural properties including but not limited to silicon carbide and silicon nitride and which can be applied in a number of formats including but not limited to chemical vapor deposition, pre-ceramic polymeric pastes, and ceramic matrix composites.

14. A method and deposition cartridges for increasing the production rate and/or decreasing the energy consumption per unit of production of a deposition reactor normally utilizing seed rod pairs or basic deposition plates, comprising the steps of:
a. Replacing the seed rod pairs or the basic deposition plates in the deposition reactor with deposition cartridges whose total average effective deposition surface area is increased over the total average effective deposition surface area of the seed rod pairs or basic deposition plates to the extent required to give the desired increase in production rate and/or decrease in energy consumption per unit of production, within the physical limitations of the reactor, such as internal volume and maximum deposition gas flow rate
b. Running the standard deposition cycle of the deposition reactor with the exception that the average deposition gas flow rate can be higher and the cycle duration can be shorter than when seed rods or basic solid deposition plates are utilized
c. Removing the deposition cartridges with crusts of deposited material from the deposition reactor and taking them to a separate recovery station
d. Heating the deposition cartridges to or above the melting temperature of the deposited material such that a thin layer of the material liquefies at the deposition cartridge interfaces and the crusts detach from the deposition cartridges
e. Separating the detached crusts from the deposition cartridges by application of a suitable force such as gravitational force or mechanical force
f. Returning the deposition cartridges to the Siemens reactor and repeating steps b-e above.
